(19) United States
(12) Patent Application Publication
(10) Pub. No.: US 2012/0118241 A1
(43) Pub. Date: May 17, 2012

(54) PET WASTE MANAGEMENT SYSTEM

(76) Inventors: Tilden A. SMITH, II, Westminster, CA (US); Dylan M. Balsz, Tustin, CA (US)

(21) Appl. No.: 12/948,422

(22) Filed: Nov. 17, 2010

(51) Int. Cl. A01K 29/00

(52) U.S. Cl. 119/167

(57) ABSTRACT

The present invention for a pet waste management system for use by domestic animals includes a shallow container; having a bottom and four sidewalls, for receiving and collecting domestic animal waste product, excrement, and urine, a receptacle combined with the container, for holding and dispensing plastic disposal bags for the animal excrement, a moisture absorbent pad, a polymeric grid disposed within the container for providing support for the weight of the animal, and a porous synthetic green grass surface shaped to overlie the polymeric grid base.

Household pets and smaller domestic animals may require receiving structures for animal waste product. For example, a pet owner may construct a receiving receptacle out of a box or tray with a lining of sand, litter, or other absorbent material. A litter box is a commonly used receptacle for household pet waste. In many instances the family pet can be trained to urinate or defecate in the box or tray. The pet owner can clean up after the pet at a later interval.

Often times, however, the pet prefers not to use a litter box or finds other functions for the absorbent materials. Paws may become the carrier of soiled litter or excrement with the results of previous visits to the litter box scattered throughout the house. This may leave the pet owner with the dilemma of repeated pet training, labor intensive cleaning of the receiving receptacle area, removing debris or stains from soiled floors, or clearing of odors from laid open indoor boxes.

It may not be convenient to clean the sand or litter box, and despite the frequency of removing waste product, the pet owner may fall victim to the unpleasant odors emanating from a soiled tray particularly where the pet box resides indoors, especially in small apartments. Generally, litter trays are kept in dry locations and not typically used on balconies. These boxes are typically used for cats and not for other household animals, such as rabbits, guinea pigs, or dogs. It may be difficult for dog owners who live in houses or apartments without backyards and grass to satisfy their household pet's toiletry needs.

U.S. Pat. No. 7,584,717 to Skovron discloses a portable toilet for animal use. This toilet includes a catchment to channel urine into the collection part. The catchment includes concave surface shaped to channel urine into a drain located over the collection part. The catchment includes a sloped surface that is shaped to channel urine into the drain. A layer of synthetic grass is used for traction and to cover the catchment. In an alternative embodiment, the toilet includes a real grass upper surface.

U.S. Pat. No. 7,748,348 to Hurwitz discloses a collapsible animal litter pan with shallow sides that enable a pet to enter the use area and leave without pet litter spillage. The litter pan has three folding locations connecting four segments and a plurality of hinges to collapse and expand the litter pan. The pan portion of the litter pan is adapted to receive a urine absorption sheet dimensioned to match the litter pan dimensions between the sidewalls thereof, when the pan is in the expanded condition. The urine absorption sheets include an adhesive coating for securing the sheet in the pan and for maintaining the integrity of the sheet so that is remains stationary during use.

U.S. Pat. No. 7,150,242 to Schuster discloses an animal litter box, which is configured to urge an animal toward a desired orientation in the litter box. The litter box is “configured” to urge the animal toward the desired orientation by providing the litter box with one or more “cues” which are associated with the litter box and which are selected and configured to urge the animal toward the desired orientation. A cue may urge the animal toward the desired orientation either by attracting the animal to the cue or by repelling the animal from the cue.

U.S. Pat. No. 7,249,570 to Robertson discloses a non-skid absorbent pad for use by animals including an upper absorbent layer for receiving animal wastes with a peripheral edge and a top and bottom surface and a bottom layer having a top and bottom surface impermeable to fluids. Adhesive and fragrance are included in the apparatus which is disposable.

It is generally desirable to lessen stress on the animal and its owner from any of the above mentioned difficulties and to provide useful alternatives. The pet waste system could therefore be appropriate for use in small close locations or on a balcony; while advantageously making available to the pet owner materials for immediate waste clean up. There remains a need in the art for a pet waste system that allows the pet to easily enter the area without unnatural motions for the animal, relieve itself, and step away from the area without spilling waste or retaining litter material. There remains a need in the art for a pet waste system that allows the indoor household pet to urinate or defecate in a receptacle appropriate for use on a balcony. There also remains a need in the art for a household waste receptacle for pets that are accustomed to grass, which could be used indoors or outdoors or in confined areas. There is a need in the art for a household pet waste system designed to allow pet owner discretion whether or not use an absorbent pad for waste containment.

Additionally there remains a need in the prior art to allow the pet owner to conveniently find a bag or multiple bags, as needed, to dispose of animal waste immediately after the waste deposit or in the immediate area of the waste receptacle.

### SUMMARY OF THE INVENTION

In accordance with the present invention, a pet waste management system for use by domestic animals includes a shallow container, a receptacle for holding and dispensing plastic disposal bags, a polymeric grid support, a porous synthetic green grass surface, and multiple plastic disposal bags.

In addition, one of the container sidewalls includes a narrow slot on a protruding rim for dispensing of the disposal bags from the receptacle. This convenience is not provided by prior art devices. Preferably, the shallow container is constructed with a bottom and four sidewalls, for receiving and collecting domestic animal waste product, excrement, and urine.

Preferably, the pet waste management system includes an absorbent pad disposed on the bottom of the container for collecting animal urine. Alternatively, the pet waste management system may be used without the absorbent pad. This embodiment enables the owner to use the pet waste system with various domestic pets and their particular absorbent material requirements. This would allow the pet owner to use his or her discretion whether or not use an absorbent pad for pet waste containment.

A receptacle is combined with the container for holding and dispensing plastic disposal bags for the animal excrement. The receptacle may be disposed and accessible on the underside of the protruding container rim and aligned with the dispensing slot. The receptacle may be detachable from the container rim.

A conventional modular polymeric grid is disposed within the container for providing support for the weight of the animal. The polymeric modular grid base protrudes at regular intervals to raise the base off the surface of the underlying absorbent pad and container bottom. The protrusions are sufficient in length to allow air circulation above the absorbent pad and under the porous synthetic grass for drying of animal waste excrement. Advantageously, the air circulation under the synthetic grass promotes odor control and outdoor use.

The polymeric grid is immune to animal urine soaking and is removable from the shallow container. Further, the polymeric components of the pet waste management system are washable.

In accordance with one aspect of the invention, a removable porous synthetic green grass surface is shaped to overlie the polymeric grid base. The porous synthetic grass is perforated and disposed for passing urine through the grid for drainage to the absorbent pad upon the bottom of the container. Household animals accustomed to grass or synthetic grass could be trained to use the invention indoors, outdoors, or in confined areas. In accordance with another aspect of the invention, the pet waste management system may be used without the porous grass.

The pet waste management system includes multiple plastic disposal bags which are attached and perforated. The multiple plastic disposal bags are held in the receptacle and pulled through a dispensing slot on the container to provide fresh replacement bags by the pet owner for removal of animal waste from the pet waste management system surfaces.

### BRIEF DESCRIPTION OF THE DRAWINGS

The advantages and features of the present invention will be better understood by the following description when considered in conjunction with the accompanying drawings in which:

FIG. 1 is a perspective view of the top of the entire pet waste management system.

FIG. 2 is an exploded view of a preferred embodiment of the pet waste management system according to the invention, illustrating the shallow container with dispensing opening slot, an absorbent waste pad, a polymeric support grid and synthetic grass.

FIG. 3 is a side view illustration of FIG. 1 disposed for use.

FIG. 4 is a perspective view of the container underside and disposed waste bag receptacle.

FIG. 5 is a perspective view for open receptacle attached to the container underside.

### DETAILED DESCRIPTION

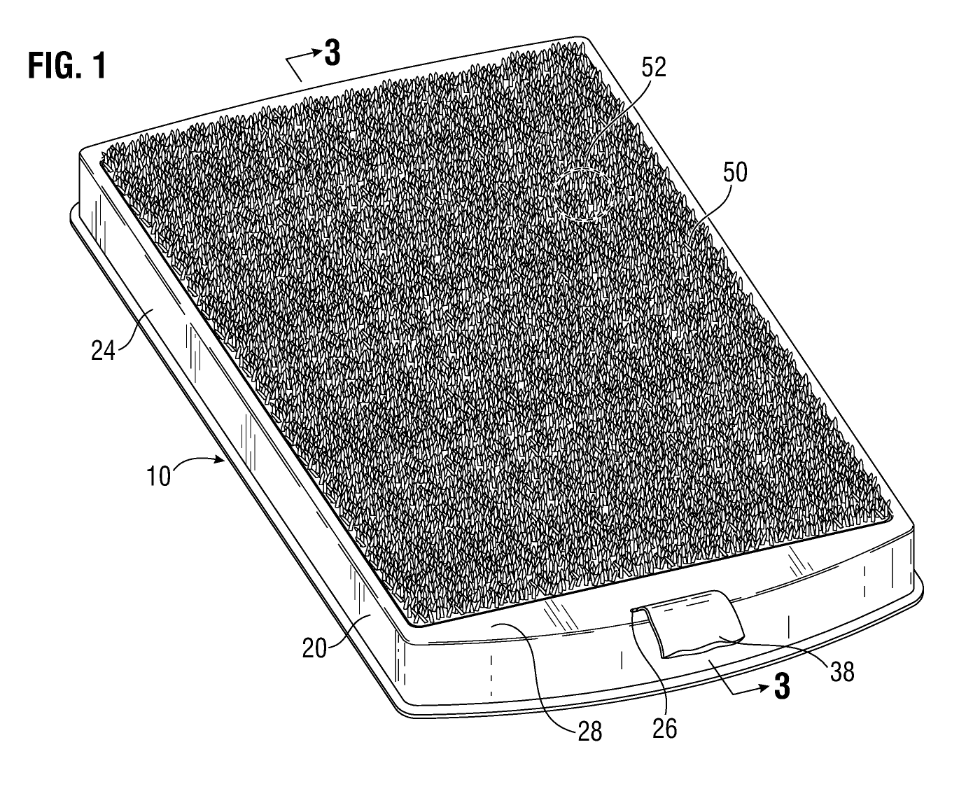

In accordance with the present invention, there is shown the pet waste management system 10 in FIGS. 1-3, generally suitable for use by household or domestic animals 12 for receiving and collecting excrement 14 and urine 16. As shown in FIGS. 1-3, the pet waste management system 10 provides a shallow container 20 constructed with a bottom 22 and four sidewalls 24, an absorbent pad 30, a receptacle 34 for holding and dispensing plastic disposal bags 36, a polymeric grid support base 44, and a porous synthetic green grass surface 50.

The shallow container provides the structure for the pet waste management system 10. The container bottom 22 provides a surface for the absorbent pad 30 and a surface for collecting animal 12 excrement 14 and urine 16. The four sidewalls 24 constrain the absorbent pad 30, the polymeric grid 44, and the synthetic grass 50, for receiving and collecting domestic animal 12 urine 16.

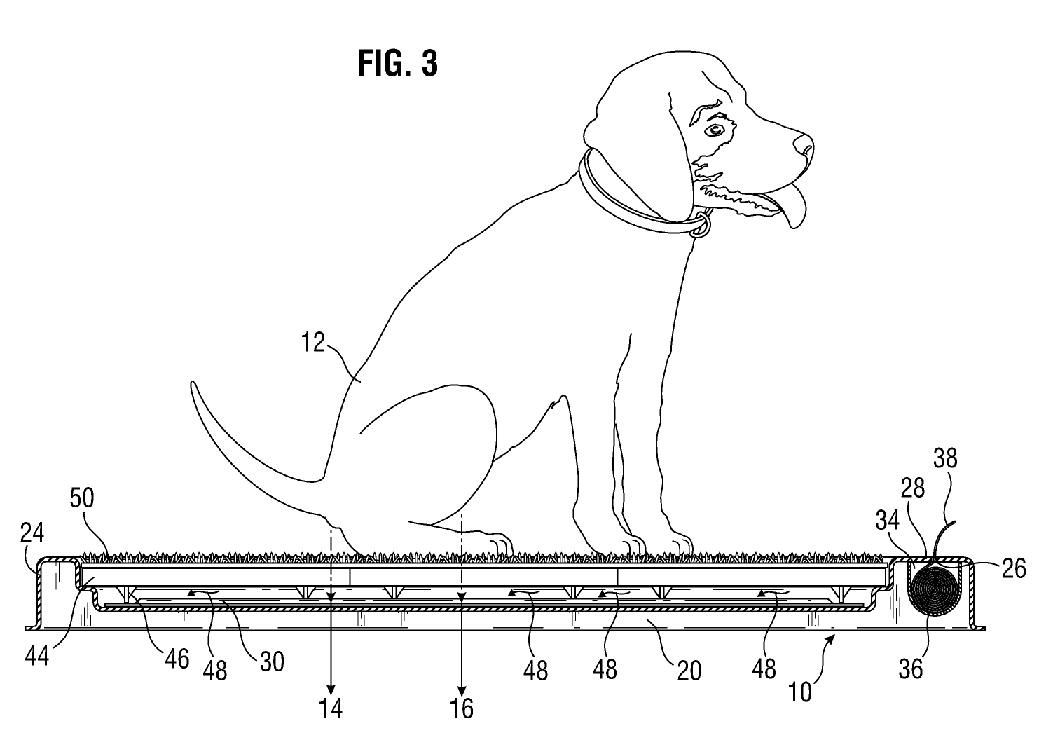

Turning to FIGS. 1 and 3, a narrow dispensing slot 26 on one of the container sidewalls 24 enables dispensing of disposal bags 36 from the receptacle 34. The bag dispensing system provides fresh disposal bags 38, as needed, to dispose of deposited animal waste 14. As particularly shown in FIG. 3, the plastic disposal bags 36 are disposed in a receptacle 34 and pulled through the dispensing slot 26 on the container rim 28. The plastic disposal bags 38 are then used to collect animal waste 14 from the pet waste management system 10 surfaces.

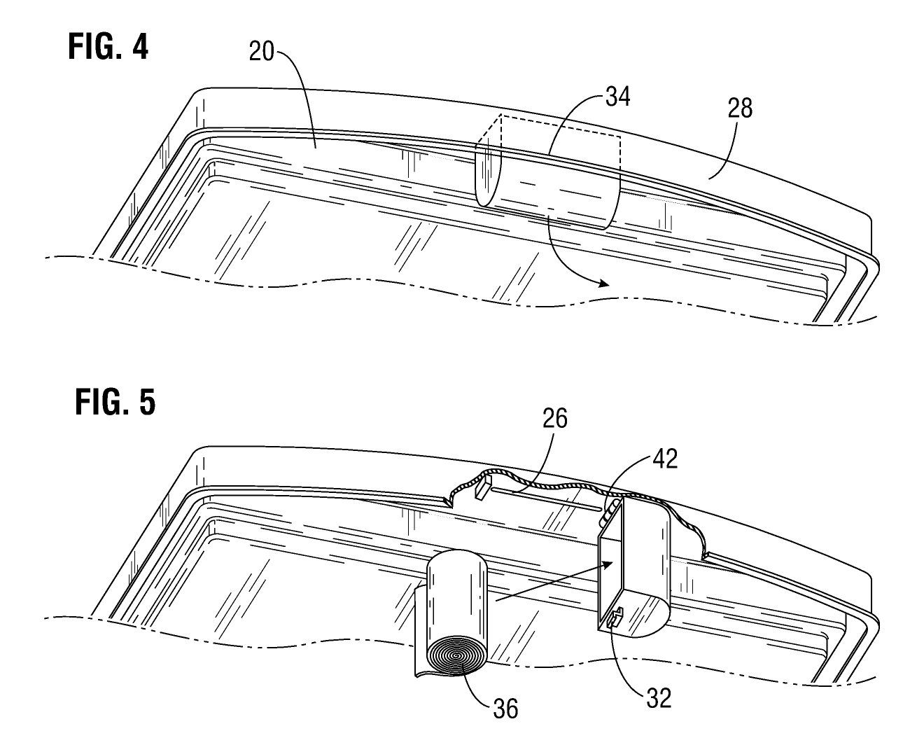

Preferably as shown in FIGS. 3-5, the attached receptacle 34 is accessible and is combined with the container 20. As shown in FIGS. 4 and 5, the receptacle 34 is disposed on the underside of the protruding rim 28 and may be detachable 32. As illustrated in FIG. 5, the detached receptacle 32 holds multiple plastic disposal bags in a roll 36. A disposal bag 38 is pulled through. the dispensing slot 26 from a roll 36 to the top side of the pet waste management system 10 as depicted in FIG. 3. The receptacle is reattached 32 to the container 20, as shown in FIG. 4. While a hinge 42 arrangement is shown for enabling detachment of the receptacle 34 to the rim 28, any suitable attachment means may be used.

Preferably, the pet waste management system 10 includes an absorbent pad 30 disposed on the bottom of the container 22 for collecting animal urine 16 as depicted in FIG. 3. Upon soiling, the absorbent pad 30 is discarded and replaced with a fresh absorbent pad 30 for future use. Alternatively, the pet waste management system 10 may be used without the absorbent pad 30. This embodiment enables the owner to use the pet waste system with various domestic pets and their particular absorbent material requirements.

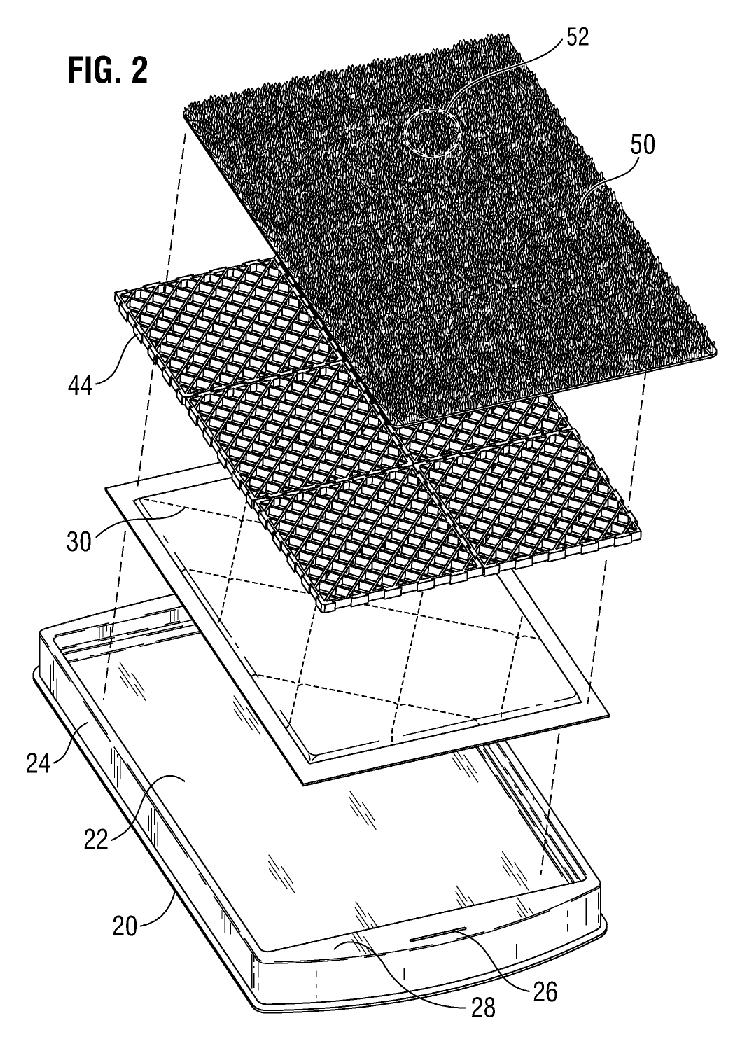

As shown in FIGS. 2 and 3, the polymeric grid base 44 is placed within the shallow container 20 for providing support for the weight of the animal 12. The grid 44 is a conventional modular design and the grid base includes protrusions 46 at regular intervals to raise the base off the surface of the underlying absorbent pad 30 and container bottom 22 as shown in FIG. 3. The grid protrusions 46 are sufficient in length, typically in the range of 0.25 to 0.75 inches, to allow air circulation 48 above the absorbent pad and under the porous synthetic grass for drying of animal waste excrement 14, 16. Further, the polymeric components including the container 20, the modular grid 44, and the synthetic green grass 50 are immune to urine soaking and are washable.

In accordance with one aspect of the invention, a removable porous synthetic green grass surface 50 is shaped to overlie the polymeric grid base 44. The green grass surface simulates 50 an outdoor surface familiar to the domestic or household pet. As shown in FIGS. 1-3, the porous synthetic grass includes perforations 52 and is disposed for passing urine 16 through the grid 44 for drainage and collection to the absorbent pad 30 or to the bottom of the container 22. The synthetic grass 50 is removable from the polymeric support grid support 44 and is washable. In accordance with another aspect of the invention, the pet waste management system 10 may be used without the porous grass 50, thereby allowing urine 16 to pass through the polymeric grid to be collected on the container bottom 22 or to an absorbent pad 30.

Although there is described hereinabove a specific arrangement of a pet waste management system in accordance with the present invention for the purpose of illustrating the manner in which the invention can be used to advantage, it will be appreciated that the invention is not limited thereto. Accordingly, any and all variations and modifications, which may occur to those skilled in the art are to be considered to be within the scope and spirit of the invention as defined in the appended claims.

What is claimed is:

1. A pet waste management system for use by domestic animals comprising:
a shallow container, having a bottom and four sidewalls, for receiving and collecting domestic animal waste product, excrement, and urine;
a receptacle combined with the container, for holding and dispensing plastic disposal bags for the animal excrement;
an absorbent pad disposed on the bottom of the container for collecting animal urine;
a polymeric grid disposable within the container for providing support for the weight of the animal within said shallow container;
a porous synthetic green grass surface shaped to overlie the polymeric grid base; and
multiple plastic disposal bags disposable in said receptacle for removing animal waste from the pet waste management system surfaces.

2. The system of claim 1, wherein one of said container sidewalls includes a narrow slot on a protruding rim for enabling dispensing of the disposal bags from the receptacle.

3. The system of claim 2, wherein said receptacle is disposed on an underside of said protruding rim.

4. The system of claim 3, wherein the receptacle is aligned with the dispensing slot on the rim.

5. The system of claim 4, wherein the receptacle is accessible 36 on the container rim.

6. The system of claim 5, wherein the receptacle is detachable from the container rim.

7. The pet waste management system according to claim 1, wherein said polymeric grid is immune to animal urine soaking and is removable from the shallow container.

8. The system of claim 7, wherein said porous synthetic grass surface is removable from the polymeric support grid.

9. The system of claim 8, wherein said porous synthetic grass is perforated and disposed for passing urine through the grid for drainage to the absorbent pad upon the bottom of the container.

10. The pet waste management system according to claim 8, wherein the polymeric grid is modular.

11. The pet waste management system according to claim 10, wherein the polymeric modular grid base protrudes at regular intervals to raise the base off the surface of the underlying absorbent pad and container bottom.

12. The pet waste management system according to claim 12, wherein the polymeric grid protrusions are a sufficient length to enable air circulation above said absorbent pad and under said porous synthetic grass for drying of animal waste excrement.

13. The system of claim 2, wherein said multiple plastic disposal bags are attached and perforated to yield a fresh replacement bag through said dispensing slot until the plurality of bags is exhausted.

14. The pet waste management system according to claim 1, wherein the polymeric components are washable.

15. The pet waste management system comprising;
a shallow container, having a bottom 14 and four sidewalls, for receiving and collecting domestic animal waste product, excrement, and urine;
a receptacle combined with the container, for holding and dispensing plastic disposal bags for the animal excrement;
a polymeric grid disposable within the container for providing support for the weight of the animal within said shallow container;
a porous synthetic green grass surface shaped to overlie the polymeric grid base; and
multiple plastic disposal bags disposable in said receptacle for removing animal waste from the pet waste management system surfaces.

16. A pet waste management system for use by domestic animals comprising:
a shallow container, having a bottom and four sidewalls, for receiving and collecting domestic animal waste product, excrement, and urine;
a receptacle combined with the container, for holding and dispensing plastic disposal bags for the animal excrement;
an absorbent pad disposed on the bottom of the container for collecting animal urine;
a polymeric grid disposable within the container for providing support for the weight of the animal within said shallow container; and
multiple plastic disposal bags disposable in said receptacle for removing animal waste from the pet waste management system surfaces.
